(19) United States
(12) Patent Application Publication
(10) Pub. No.: US 2022/0145601 A1
(43) Pub. Date: May 12, 2022

(54) MULTIFUNCTION TAP

(71) Applicant: James Kenneth MCALPINE, Glasgow (GB)

(72) Inventor: James Kenneth MCALPINE, Glasgow (GB)

(21) Appl. No.: 17/430,684

(22) PCT Filed: Feb. 12, 2020
(86) PCT No.: PCT/GB2020/050318

§ 371 Date: Aug. 12, 2021

(30) Foreign Application Priority Data
Feb. 12, 2019 (GB) 1901935.5
Dec. 16, 2019 (GB) 1918532.1

(51) Int. Cl. E03C 1/04; E03C 1/044; E03C 1/05; C02F 1/78

(52) U.S. Cl. CPC E03C 1/0411; E03C 1/044; E03C 1/055; C02F 2307/06; E03C 2001/0415; E03C 2201/40; C02F 1/78

(57) ABSTRACT

A multifunction tap assembly (18) for dispensing water, includes a tap body with a spout (2) for dispensing water. A valve body (6) has a mixer valve (8) including an inlet for water (20) from a hot water supply (H), an inlet for water (22) from a cold water supply (C), and an outlet. A selector control (14) on the valve body (6) can selectively direct cold water (30, 32) from the cold water supply to one or more water processing stations (34, 38). Each water processing station (34, 38) has an inlet for receiving cold water from the cold water supply as directed by the selector control (14) and processes the cold water to provide a processed water (36, 40) for dispensing from an outlet. A manifold connection (26) provides fluid communication between the outlet of the mixer valve (14) and each processing station outlet and has a manifold outlet in fluid communication with the spout (2).

### FIELD

The present invention relates to multifunction taps for dispensing hot, cold and specially prepared waters, such as boiling or near boiling water, for use in a domestic and/or commercial kitchen.

### BACKGROUND

For domestic and commercial use taps that can dispense extra hot water (‘boiling water’), in addition to the usual hot, cold and mixed hot and cold water, have become popular. Typically, a mixer valve supplies hot, cold, and mixed hot and cold water, with ‘boiling’ water supplied to the tap via a separate pipe from a reservoir tank underneath the sink or worktop.

Existing ‘boiling water’ tap designs can present some problems in manufacture, installation and use. For example, some boiling water tap designs make use of a pressurised tank to hold the supply of extra hot water, requiring appropriate safety features for such an installation.

There remains the desire to provide alternative multi-functional tap designs, that can be readily installed, are reliable in use and can provide water to suit various uses.

### SUMMARY

According to a first aspect of the invention there is provided a multifunction tap assembly for dispensing water, the tap assembly comprising:

a) a tap body including a spout for dispensing water;

b) a valve body;

c) a mixer valve on the valve body including an inlet for water from a hot water supply, an inlet for water from a cold water supply, and an outlet;

d) a selector control for selectively directing cold water from a cold water supply to one or more water processing stations;

e) one or more water processing stations, each having an inlet for receiving cold water from the cold water supply as directed by the selector control; and each formed and arranged to process the cold water received to provide a processed water for dispensing from a respective processing station outlet; and

f) a manifold connection, the manifold connection in fluid communication with the mixer valve outlet and each processing station outlet; and having a manifold outlet in fluid communication with the spout.

Connections allowing fluid communication between the inlets and outlets of the tap assembly components maybe made by flexible hose or rigid pipe connections in the conventional way. Flexible hoses may allow easier fitting of the components of the tap assembly in different situations.

The manifold connection may be provided as a separate item i.e. spaced apart from the tap body, valve body and mixer valve. Connection can be by flexible hose or rigid pipe connections in the conventional way. This arrangement can be convenient, avoiding increasing the bulk of the tap components to accommodate the manifold connection. The manifold connection may be provided (in use) below a sink or counter top surface that mounts the tap, allowing access for maintenance, repair or replacement without having to remove the tap body or valve body.

In a convenient arrangement the tap assembly of the invention is a pull-out tap assembly. To that end the spout may comprise a ‘pull out’ hose. In which case the pull out hose may extend from the dispensing end of the spout, through the valve body (for example through a chamber in the valve body) to beneath the valve body. In such an arrangement all the hoses or pipes to and from the tap body and valve body may extend below the valve body in a relatively compact bundle. This can allow ready fitment of the tap assembly through an aperture in a worktop or sink, in a generally conventional manner, as for a typical mixer tap or boiling water tap arrangement.

The pull out hose may be provided within a tube of the tap body. The pull out hose can be pulled from the tube and water flow directed to a selected location. The pull out hose may be self-retracting into the tube, for example by means of a weight attached to a portion of the hose under the tap.

Conveniently the pull out hose may be directly connected to the manifold connection.

The pull out hose may comprise at least two separated fluid pathways along its length, for example an arrangement where one fluid pathway in the form of a hose is present inside another e.g. a so called “co-extruded” hose arrangement. In such an arrangement the two hoses may be concentric. Conveniently the pathway for processed water may be a hose inside the pathway for water from the mixer valve. This can provide a degree of safety when the processed water is near boiling (e.g. at about 98° C.). The outer pathway for water from the mixer valve provides a degree of insulation between a user and the extra hot water.

Having different fluid pathways for the water directed to the spout can have other advantages. The water flow from the mixer valve (cold, hot or mixed) need not contaminate the water from the water processing stations, as delivery to, and even out of the spout can be along separate fluid pathways, from the manifold connection.

The end of the spout may be fitted with a nozzle for adjusting the flow of water. For example, the outlet end of the spout (which may be the outlet end of a pull out hose) may have a control lever or button that allows the user to change the water stream to a spray, in the known manner for conventional tap assemblies. The nozzle may act only on water from the water pathway from the mixer valve, thereby avoiding a spray action from very hot water, for example.

The selector control may be on the valve body. Alternatively, the selector control may be elsewhere, for example on the tap body (e.g. the spout).

The selector control may be a selector valve on the valve body for selectively dispensing cold water from a cold water inlet to one or more water processing stations via a respective selector valve outlet. The cold water inlet for the mixer valve on the valve body may provide the cold water supply to the selector valve. To do so the cold water inlet may divide in two at the valve body, with cold water supplied to the mixer valve and the selector valve. Conveniently the cold water inlet may connect to a chamber of the valve body that receives the cold water. The chamber connects to the selector valve and to the mixer valve, for supply to both. The use of a chamber supplying both mixer and selector valves is convenient in reducing the number of distinct fluid pathways required at the valve body, for a multifunction tap.

Alternatively, the selector control may be an electronic control, for example an electronic control activated by a user of the tap to send a signal for example by wire or wirelessly to command operation of a valve or valves. The valve or valves direct the dispensing of cold water from a cold water supply to one or more water processing stations. The electronic control may comprise a push button, a lever, a rotating dial, or a touch pad or button type of activation interface with a user, or any combination of these. Use of a selector control making use of one or more proximity type switches can be convenient. For example, where movement of a lever or rotation of a dial is to turn a water flow on or off. A proximity switch used with such a feature does not require making a physical electrical connection. The valve or valves may be, for example, solenoid valves, or motor driven valves. Where an electronic control is provided it can reduce the number of flow paths and corresponding channels or pipes for water that connect to the valve body and/or the tap body. A water inlet is not required to connect to the selector control when it is not a selector valve.

In use of the tap assembly, a cold water supply is required to supply the mixer valve and to supply the water processing station(s). Where the selector control is a selector valve one cold water supply connection may be employed as discussed above. Where the selector control is an electronic control the cold water supply may be different from that used for the mixer valve. However, it is convenient for most situations if a single cold water supply is used. The single cold water supply may be provided via a hose or pipe arrangement that divides (i.e. branches) to supply the mixer valve and each water processing station employed in the assembly.

The manifold connection of the tap assembly receives water from the mixer valve outlet and each processing station outlet. It directs the received water to the spout via the manifold outlet. The manifold connection may be provided with one or more non-return valves to prevent misdirection of a water flow (i.e. ‘check’ or non-return valves). The connection to the spout may be a conventional hose or pipe connecting to the tap body. As discussed above in a convenient arrangement the connection to the spout may be by a hose or pipe that comprises at least two separated fluid pathways along its length, for example a pipe arrangement where one pipe is present inside another, which may be a so called “co-extruded” pipe arrangement. In such arrangements the two pipes may be concentric. Having different fluid pathways for the water directed to the spout can be advantageous. The water flow from the mixer valve (cold, hot or mixed) need not contaminate the water from the water processing stations, as delivery to and even out of the spout can be along separate fluid pathways, from the manifold connection.

The valve body may be mounted to the tap body e.g. on the spout or on a base of the tap body that mounts the spout.

The valve body may be mounted transverse to the spout. The valve body may be transverse to and about the spout with a passage therethrough for passage of water being dispensed from the spout. In such tap arrangements the mixer valve and the selector control may be mounted one at either end of the valve body.

In such an arrangement where the selector control is a selector valve, the passage for the water being dispensed from the spout is between the mixer and selector valves at either end of the valve body. Where a chamber in the valve body is used to receive cold water to supply both the mixer valve and the selector valve, the passage for the water being dispensed from the spout may pass through the chamber receiving cold water.

The mixer valve may operable to provide hot, cold, or mixed hot and cold water. The mixer valve may be of a conventional single lever type, where on/off and choice of hot, cold, or mixed hot and cold water is made by appropriate movement of the lever.

The valve body and the tap body of the tap assembly described herein constitute a multifunction tap.

Thus, according to a second aspect the present invention provides a multifunction tap, the multifunction tap comprising:
a) a tap body including a spout for dispensing water;
b) a valve body including a cold water inlet;
c) a mixer valve on the valve body including an inlet for water from a hot water supply, an inlet for water from a cold water supply, and an outlet; and
d) a selector control on the tap body or the valve body for selectively directing cold water from a cold water supply to one or more water processing stations.

The multi-function tap can form part of the tap assembly of the invention; and so can have any or all of the features discussed herein for a tap used with the tap assembly.

For example, the selector control may be a selector valve as discussed above with respect to the tap assembly of the invention.

The cold water inlet on the valve body may provide the cold water supply to the mixer valve as well as to the selector valve. To do so the cold water inlet may divide in two at the valve body, or the cold water inlet may connect to a chamber of the valve body that receives the cold water. As discussed above in relation to the tap assembly, the chamber connects to the selector valve and to the mixer valve, for supply to each.

The selector valve may be provided with a plurality of selector valve outlets, each of which can be selected for use by setting the selector valve.

The multifunction tap of the second aspect of the invention may conveniently be supplied fitted with inlet and outlet hoses as discussed above. Where the valve body is mounted to the tap body, the tap with hoses fitted can form a convenient unit for fitting to a sink or other workstation. In the same way as for a conventional tap, the tap can be mounted to a sink or a worksurface with the hoses passing through and below for connection to water supplies, processing stations and the manifold connection. Processing stations and the manifold connection can be fitted beneath the sink or worksurface.

Thus, the multifunction tap can present a generally similar appearance and size to that of a conventional multifunction tap, or even to that of a conventional mixer tap.

The manifold connection receives water from the mixer valve and the processing stations and directs the received water to the spout. The manifold connection may be a pipe fitting having suitable screw or other releasable fixings for connecting hoses or pipes from the mixer valve and the processing stations, and an outlet hose or pipe to the spout. For example, where the tap assembly is used to supply water from the mixer valve and processed water from only one processing station, a simple ‘Y’ or ‘T’ connector piece with fixings to connect three hoses or pipes can constitute the manifold connection. (One connection being made to send water to the spout, the other two receiving water from the mixing valve and the processing station respectively).

Where two processing stations are used, then four connections are required. Therefore, a cross or ‘X’ connector may be used. Additional feeds of processed water can be accommodated by adding more arms to the connector and/or by employing a manifold connection of another form. For example, a central pipe with branches off. Each end of the pipe and each branch being for connecting to a hose or pipe.

The manifold connection may be fitted with one or more check valves i.e. one way valves. For example, an inlet to the manifold connection may be provided with a one-way valve allowing forwards flow (from the mixer valve or a processing station towards the dispensing end of the spout), whilst preventing reverse flow (from the manifold back towards the mixer valve or a processing station). Check valves can aid in avoiding cross contamination of one water source (e.g. drinking water) with another (e.g. a processed water)

In the multifunction tap of the invention, the spout may be of the pull out hose type, where a hose provided within a tube carries the water received from the manifold outlet. The pull out hose can be pulled from the tube and water flow directed to a selected location. The pull out hose may be self-retracting into the tube, for example by means of a weight attached to a portion of the hose under the tap. Conveniently the pull out hose may be directly connectable to the manifold connection in a tap assembly of the invention.

The tap assembly according to the first aspect of the invention comprises at least one water processing station, receiving cold water from a supply and processing it. The processed water is sent via the manifold connection, to the spout.

The tap assembly may be ‘open to atmosphere’ for some or even all of the routes for water dispensing i.e. without substantial obstruction (such as a closable valve) to forwards flow, after water leaves the mixer valve or a water processing station. For example, water from the mixer valve may flow via the manifold connection to the dispensing end of the spout without closure valves in between. (One way valves allowing forward flow, but not backwards flow may be present in some circumstances.)

Similarly, water may flow from a water processing station, then via the manifold connection to the dispensing end of the spout without closure valves in between.

Where more than one processing station is provided any or all may have a route without closure valves from the processing station and manifold connection to the dispensing end of the spout.

Where the tap is open to atmosphere, flow and flow rate of water is controlled by the operation of the mixing valve and/or the selector control. Thereafter water flows through the processing station(s) and manifold connection out of the spout.

This can be advantageous in avoiding the use of pressure vessels in water processing stations. For example, in some conventional arrangements of ‘boiling water’ dispensers, water is heated in a tank that is closed at both inlet and outlet ends, i.e. the tank is a pressure vessel, at least until the heated water is being dispensed.

The at least one water processing station may be a so called ‘boiling water’ dispenser, that provides extra hot, for example near or at boiling temperature water. Such devices heat a tank of cold water, that has been supplied from a cold water supply, under the command of the selector control. Supply of more cold water displaces extra hot water out of the tank via the processing station outlet and to the manifold connection, then out of the spout. Thus, delivery of extra hot water is controlled by the operation of the selector control as it delivers cold water to the tank of the (boiling water) processing station. If desired the water supplied may be filtered or otherwise treated before or after entering the heating tank. For example, an in-line filter may be employed. The extra hot water may be supplied from the processing station at a temperature of >90° C. or even >95° C., typically at about 98° C.

To minimise energy usage the tank will normally be insulated to aid in keeping the water hot. Additional energy saving may be made by providing the tank with a timer control. The timer control can be used to turn off the heating for the tank during periods when the extra hot water is not or is unlikely to be required e.g. late at night and/or during the middle of weekdays when members of the household are out.

The timer control may be arranged to be overridden when extra hot water is demanded by use of the selector control. The tank heater will then heat the tank contents up to the operating temperature. The tank may then continue to be heated for a set period (e.g. one hour), before reverting to the off mode (if the timer control setting is still at ‘heating off’).

As discussed further below with reference to particular embodiments, a venturi and bladder arrangement may be fitted to the extra hot water station, typically in the pipework supplying the cold water into the tank, after a valve that controls the supply. Such an arrangement can provide the advantage of drawing residual extra hot water (left in the tap and its pipework after use), back into the tank. This can avoid unexpected dribbling of extra hot water from the tap. This clearing of water from the tap is convenient when the tap is to be used for another type of water on its next use.

More generally venturi and bladder arrangements may be fitted to any or all of the water types supplied to the tap to provide a pipework clearing action at the tap after use. Advantageously, each of an extra hot water station and a cold water (e.g. a filtered and/or chilled cold water) station is provided with their own venturi and bladder arrangements. The water clearing action of the venturi and bladder arrangement removes residual cold water from the pipework, allowing a rapid change to the extra hot water supply and vice versa.

The removal of residual cold water from the pipework to the tap can also avoid dripping when the extra hot water tank is heating water up to the required temperature. The cleared pipework from the extra hot water tank to the tap provides a space for expansion of the heated water, in addition to that provided by the venturi arrangement.

Where a pull out type hose is employed in taps and tap assemblies of the invention, a further potential source of dripping is caused by distortions of the pull out hose in the spout (caused e.g. by pressure and/or temperature changes). These distortions may disturb residual water in the pull out hose or in the spout surrounding the retracted pull out hose. It has been fond advantageous to provide a pull out hose (typically of a silicone rubber or other polymer) with a Shore durometer hardness (type A) of 50 or more in taps and tap assemblies. This degree of hardness has been found to reduce dripping.

In a convenient arrangement the tap assembly may comprise a filtered water processing station and an extra hot water processing station.

Where the selector control is electronic, commanding operation of valves, the cold water inlet for the extra hot water processing station may connect to the cold water supply via the filtered water processing station i.e. the extra hot water produced will be filtered extra hot water, making use of the same filter station that supplies filtered water to the spout via the manifold connection. The filtered water processing station may have two outlets or one outlet that divides in two branches. This allows direction of filtered water to either the inlet of the extra hot water processing station or directly to the manifold connection. Opening a valve (e.g. a solenoid valve) on one outlet or branch allows filtered water to progress to the extra hot water station. Opening another valve (e.g. a solenoid valve) on the other outlet or branch allows filtered water to progress to the manifold connection.

Conveniently the filtered water station is separate from the extra hot water station to provide easy access to the filter or filters for replacement.

Conveniently the extra hot water station may be provided in a container including an inlet from the filtered water station that branches to provide (via valves) a supply to the manifold connection and a supply to the extra hot water station tank. In such an arrangement a single cold water supply can be divided to provide one connection to the mixer valve and one connection to the filtered water processing station inlet.

If desired such arrangements may be extended so that filtered water can be supplied to the tap and to more than one other water processing station. The filtered water processing station can be provided with multiple outlets or an outlet that has multiple branches, the outlets or branches are fitted with control valves under the command of the selector control.

In a convenient arrangement a supply of cold water, for example cold filtered water from a water filtering station may be supplied to a container (box) holding an extra hot (‘boiling’) water processing station and another water processing station such as a water chilling station. The supply of cold water is divided into two flows (e.g. by a T piece in the pipework), with one flow directed to the extra hot (‘boiling’) water processing station and the other to the other water processing station. Valves such as solenoid valves are fitted into each flow. The selector control is used to control the flow through the solenoid valves to produce either extra hot (‘boiling’) water or another processed water (e.g. chilled water) each of which is directed to the manifold connection. If the cold water inlet flow is from a filtering station these outputs will be filtered.

Alternatively the arrangement described above may make use of separate containers for the extra hot (‘boiling’) water processing station and the other water processing station

As a ‘boiling water’ supply (extra hot water) can present a safety risk, the selector control may include one or more safety features.

For example, where the selector control is a selector valve, the selector valve may be operated by turning a control handle or lever. When set to allow delivery of extra hot water, the handle or lever may be resiliently biased back towards an off position, where no water is dispensed. Thus, extra hot water is only produced as long as an operator holds the handle or lever against the biasing force. For further example a safety catch requiring operation of a button or the like before allowing turning of a handle or lever may be employed.

Safety features can also be provided where the selector control is an electronic control activated by a user of the tap to send a signal by wire, (or wirelessly) to command operation of a valve or valves. If activation is by the user contacting a control button, the dispensing of extra hot water may continue only whilst contact is maintained between the user and the button. The button may be an electronic touch control, not requiring motion of the button to operate. Similarly, if activation is by operation of a lever or rotating a dial, the lever or dial may be biased to the off position, requiring continuous contact by a user to maintain the water flow.

As a further alternative the operation of the tap assembly to provide a processed water, such as extra hot water, may require at least two conscious actions by a user. For example, pressing a button and moving a lever or rotating a dial to activate and/or control the dispensing of extra hot water. The button and lever or dial of the selector control may be spaced apart to reduce the possibility of accidental operation.

A further safety feature that may be provided on the selector control or elsewhere on the tap or tap assembly are one or more lights responsive to the setting of the selector control. For example, a light (e.g. a red light) may be on whilst extra hot water is being dispensed. A different colour light may be on whilst another form of processed water is being dispensed (e.g. a green light for filtered water).

The processing station may be a water softener, for example an ion exchange resin type of water softener. The processing station may include a chiller, to produce a chilled water output.

Other options for processing stations include stations that can purify water, for example by methods employing one or more of: filtration, UV light and/or chemical treatment. Thus the purified water may be a disinfected or even a disinfectant water, that may be used for cleaning purposes. The processing station may include an ozoniser, to provide a disinfected and/or disinfectant ozone treated water. In each case cold water supplied by use of the selector control can pass through the equipment at the processing station to be delivered to the spout via the manifold connection.

Where a disinfected and/or disinfectant water is produced by a processing station it may be directed via the manifold to a fluid pathway that allows the water flow dispensed from the tap to be used as a spray. For example, to an end of a fluid pathway includes a nozzle that produces a spray or is adjustable to produce a spray.

Where the connection to the spout is by a hose or pipe that comprises at least two separated fluid pathways along its length and the water flow from the mixer valve (cold, hot or mixed) is separated from the water from the water processing stations, an exception may be made for purified water. As the water flow from the mixer valve may end at a nozzle capable of producing a spray, the purified water output from a processing station may be directed into the same fluid pathway. This conveniently provides a spray of disinfected and/or disinfectant water.

An ozoniser is a particularly convenient way of producing a disinfected and/or disinfectant water flow. Conveniently, where an extra hot water station is provided, the ozoniser may make use of the same electrical supply as that used to heat the extra hot water. The same arrangement discussed below may also be employed where other water processing stations requiring electrical power are used in a tap assembly comprising an extra hot water processing station.

In a particularly convenient arrangement, the ozoniser (or any other processing station requiring an electrical supply) may be supplied as an optional accessory that is electrically connectable to the extra hot water processing station. For example, mountable to the water tank of the extra hot water processing station. The electrical connection may be by a plug and socket arrangement between the ozoniser (or other processing station) and the extra hot water station. The plug and socket may each be mounted directly to a respective body of the extra hot water tank and the ozoniser.

The water flow into the ozoniser may be from a connection to cold water supplied to the extra hot water processing station.

The water flow output from the ozoniser may be supplied to the manifold or may be directed into the flow from the mixer valve to the manifold.

As yet further option, the water flow from the ozoniser may be directed into the connection between the manifold outlet and the spout. For example, into a selected one of two or more fluid pathways proceeding to the spout.

One way valves may be fitted to the ozoniser flow hoses or pipes, as desired to avoid undesirable back flows.

The operation of the ozoniser (power supply to effect ozone production and valve to allow water inflow to the station) may be controlled by the same selector control arrangement as used for other processing stations. Alternatively, a separate control may be used, for example a control button mounted to a convenient location away from the tap body e.g. on a sink or counter top.

Thus, according to a third aspect the present invention provides a multifunction tap assembly for dispensing water; the tap assembly comprising:

a) a tap body including a spout for dispensing water;

b) a valve body;

c) a mixer valve on the valve body including an inlet for water from a hot water supply, an inlet for water from a cold water supply, and an outlet;

d) a selector control for selectively directing cold water from a cold water supply to one or more water processing stations;

e) at least an extra hot water processing station and an ozonised water producing station, each having an inlet for receiving cold water from the cold water supply as directed by the selector control; and each formed and arranged to process the cold water received to provide processed water for dispensing from a respective processing station outlet; and

f) a manifold connection, the manifold connection in fluid communication with the mixer valve outlet and each processing station outlet; and having a manifold outlet in fluid communication with the spout.

The tap assembly of the third aspect may include any or all of the features discussed herein with respect to tap assemblies of the first aspect and taps of the second aspect of the invention.

As a yet further example the water processing station for the tap assemblies described herein may be for producing sparkling water, for example by injecting carbon dioxide into cold water supplied from the chamber of the valve body.

### BRIEF DESCRIPTION OF THE DRAWINGS

FIG. 1 shows a multifunction tap in a perspective view;

FIG. 2 shows a schematic flow diagram of a tap assembly;

FIG. 3 shows a schematic perspective view of the tap assembly of FIG. 2;

FIGS. 4A to 4D 4 show a valve body in schematic views;

FIG. 5 shows an alternative tap assembly in schematic perspective view;

FIG. 6 shows a cross section of a manifold connection;

FIG. 7 shows a schematic cross section of a pull out hose end fitting;

FIG. 8 shows a manifold connection;

FIG. 9 shows an arrangement including an ozoniser water processing station; and

FIGS. 10A and 10B show operation of a bladder and venturi arrangement.

### DETAILED DESCRIPTION OF SOME EMBODIMENTS WITH REFERENCE TO THE DRAWINGS

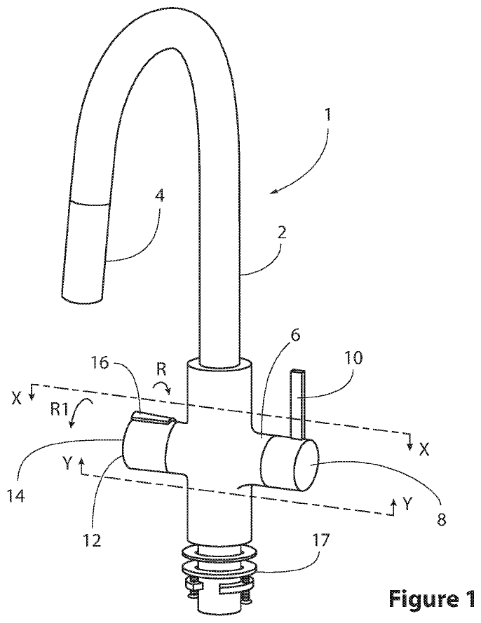

FIG. 1 shows in perspective view a multifunction tap 1 including a spout 2 for dispensing water. The end 4 of spout 2 has a pull out section which is the end of a pull out hose in this example. A valve body 6 is mounted to the spout 2 and extends transversely to either side. The valve body 6 has at one end a mixer valve 8 operated, in this example by a single lever 10. At the other end of the valve body 6 is a selector control 12, in this example a selector valve 14, including a safety button 16. Fixings 17 for fitting the tap 1 to a sink or countertop are also shown in this view.

The tap operates generally conventionally. Operating the lever 10 and rotating the external part of mixer valve 8 allows dispensing of hot, cold, or mixed hot and cold water from spout 2. Alternatively, operating safety button 16 allows rotation of the external part of selector valve 14 in one direction (suggested by arrow R) to dispense extra hot (‘boiling’) water from spout 2. The rotation R is resisted by resilient biasing so when an operator releases the valve 14 it returns to the off position shown in FIG. 1.

Rotation in the opposite direction (arrow R1) allows dispensing of another processed water (e.g. filtered water) from spout 2. Further rotation R1 can allow dispensing of an alternative processed water, if the tap is equipped to supply more than two types.

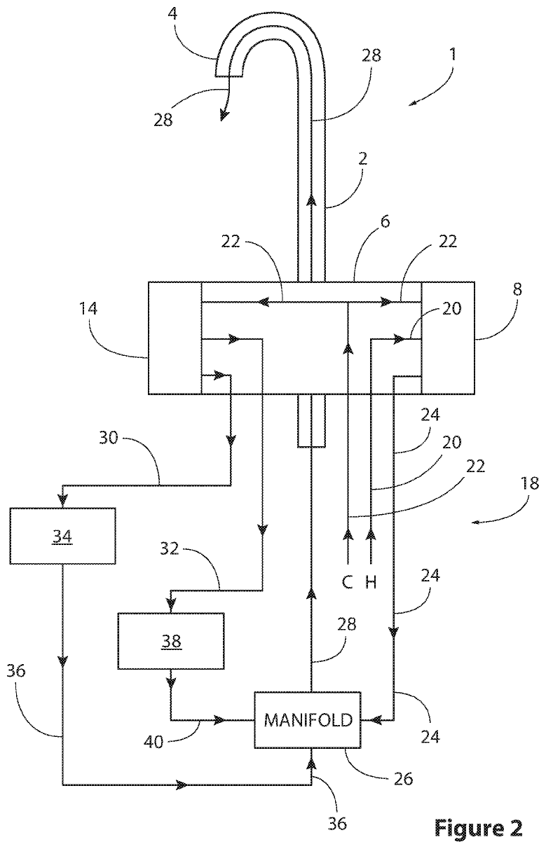

FIG. 2 shows in a flow diagram schematic, a tap assembly 18 that can make use of a tap 1, such as that shown in FIG. 1. Flows of water are shown as lines with arrows indicating direction. Valve body 6 is supplied with hot 20 and cold 22 water flows from suitable supplies (indicated by H for hot and C for cold). Hot water 20 is supplied to mixer valve 8 and cold water 22 to both mixer valve 8 and selector valve 14.

Operation of mixer valve 8 allows hot, cold, or mixed hot and cold water to be output (as flow 24) and directed to manifold connection 26. The output flow 28 from manifold connection 26 passes into spout 2, through the valve body 6 and out of the spout end 4.

Alternatively, selector valve 14 may be operated to direct cold water flow 22 as one of two output flows 30, 32.

When produced by operation of the selector valve 14 output flow 30 enters water processing station 34, in this example an extra hot water tank and heater arrangement. Cold water flow 30 displaces a supply of extra hot water (prepared and stored in station 34) as a flow 36 to the manifold connection 26, from where it passes into spout 2, passes through the valve body 6 and then out of the spout end 4 as output flow 28. Water processing station 34 may provide extra hot water by other means, for example it might be an ‘instant’ hot water system where flow 30 is heated as is passes a heating element to provide hot flow 36.

Output flow 32 enters water processing station 38, in this example a chiller unit. Chilled water exits station 38 as flow 40 and is directed to manifold connection 26 from where it passes into spout 2, passes through the valve body 6, and then out of the spout end 4 as output flow 28.

Manifold connection 26 may include one way valves to avoid undesired flow against the desired direction. Otherwise the control of the output flow is by operation of either mixer valve 8 or selector valve 14, without requiring additional closable valves.

Additional flows from selector valve 14 may be provided, each directed to a further water processing station and thence to the manifold connection for dispensing from the spout as output flow 28.

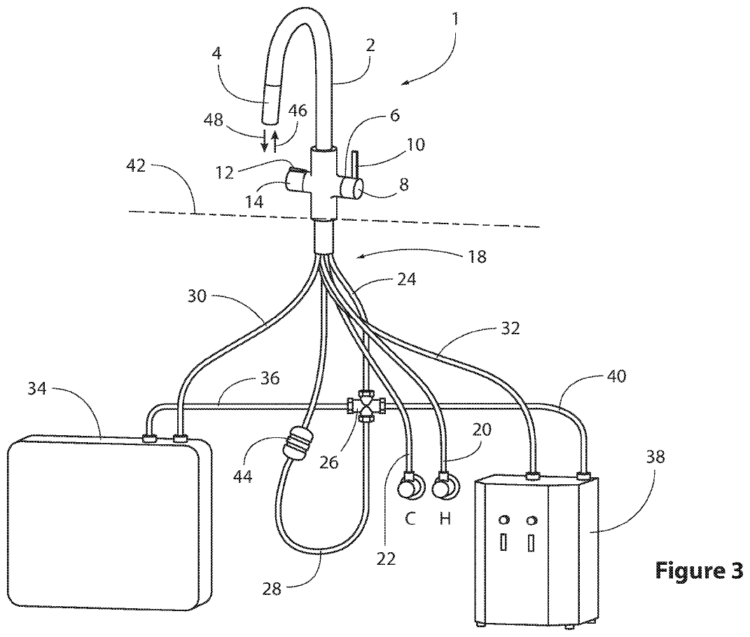

FIG. 3 shows in schematic perspective, a view the tap assembly 18 of FIG. 2, with like parts generally numbered the same as in FIGS. 1 and 2. The hoses shown in FIG. 3 are given the same number as the corresponding flow lines shown in FIG. 2. Water processing stations 34 and 38 will also be supplied with electrical power (not shown in this figure).

The layout of the tap assembly shown in FIG. 3 is as may be used in a typical under a sink or under a work top arrangement. The worktop level is suggested by dashed line 42. Hoses providing flows (20, 22, 24, 30, 32, 36 and 40) pass into the valve body 6 close to and around the hose carrying output flow 28 that dispenses out of the end 4 of the spout 2. This compact arrangement requires only a single hole in a worktop or sink for fitting the tap 1.

Manifold connection 26 is a pipe crosspiece that can be clipped to a wall at a selected position, to aid in ensuring that the hose for output flow 28 can hang down unobstructed, to allow functioning as a pull out hose. Weight 44 is attached to an upwards directed part of the hose so that after spout end 4 (which is at the end of the hose carrying flow 28) is pulled out in the direction of arrow 46, it will self-retract in the direction of arrow 48 when let go. Weight 44 is provided in two halves that fit about a hose and so can be adjusted in position to give smooth pull out and retraction of a hose.

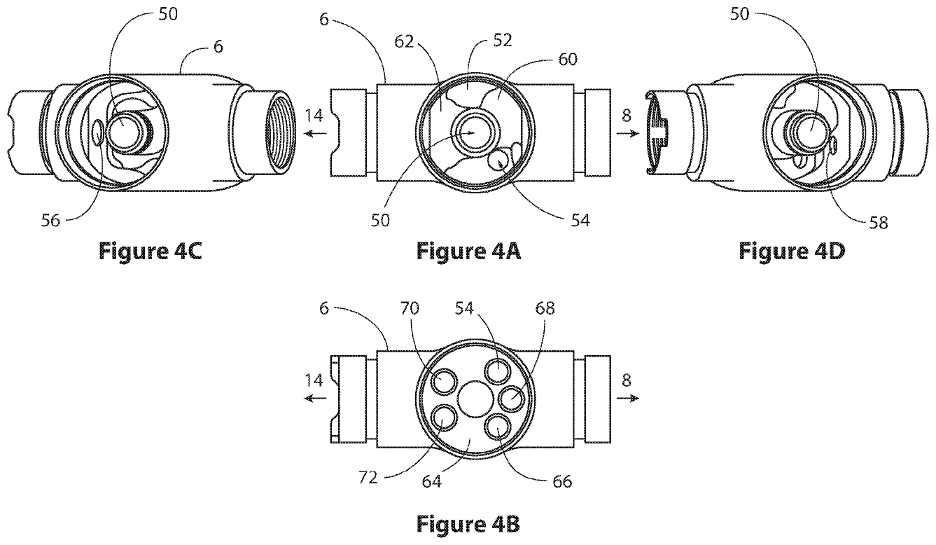

FIG. 4A shows valve body 6 in cross section plan view along line X-X and FIG. 4B shows valve body 6 in cross section from beneath along line Y-Y (FIG. 1). The valve body 6 includes an aperture 50 for the passage of a pull out hose carrying the water of output flow 28 (FIG. 3). A generally circular chamber 52 in the upper part of the valve body 6 receives water from a cold supply via aperture 54. Chamber 52 is in fluid communication with both the mixer valve 8 and the selector valve 14 (not shown in these views) via apertures 56 and 58 (as can be seen in perspective views FIG. 4C and FIG. 4D.

At the base of chamber 52 bulges 60 and 62 can be seen. These are the outside surfaces of fluid passageways directing flow to and from the mixer and selector valves. As can be seen from the bottom view FIG. 4B a disc 64 has apertures for connection to the hoses required (FIG. 3). Inlets are for the cold water supply 54 and the hot water supply 66. Outlets are for mixed water 68 (hot, cold, or a mixture from the mixer valve; and for cold water to processing stations 70, 72 (from the selector valve).

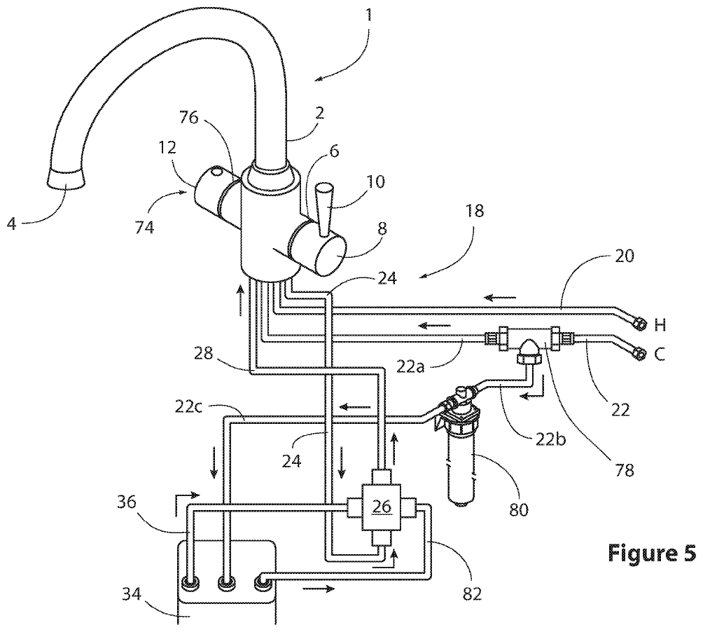

FIG. 5 shows schematically a tap 1 and tap assembly 18 arrangement similar to that shown in FIG. 3 with like parts numbered the same. The tap 1 in this example is not shown as a pull out hose type. However, the output flow 28 may advantageously be a flexible pull out hose, provided with a weight, as shown in the example of FIG. 3.

In the example of FIG. 5 the selector control 12 is an electronic control having a touch sensitive button 74 at its end. Circumferential LED lighting 76 responds to the touch of a user on button 74. Selector control 12 sends signals by wiring (not shown) passing through tap 1 and valve body 6 to command operation of solenoid valves within the extra hot water processing station 34 (container box for station 34 only shown in part).

The input water flow arrangements in the tap assembly of FIG. 5 are as follows. Hot water supply H is fed as flow 20 to the mixer valve 8. Cold water supply C provides flow 22 that is divided into two flows at T piece 78. Cold water flow 22a is fed to mixer valve 8; and cold water flow 22b to filter water processing station 80. Cold filtered water from station 80 proceeds as flow 22c into the box of extra hot water processing station 34, where it divides in two branches at a T piece (not visible). Each pipework branch is fitted with a respective solenoid valve.

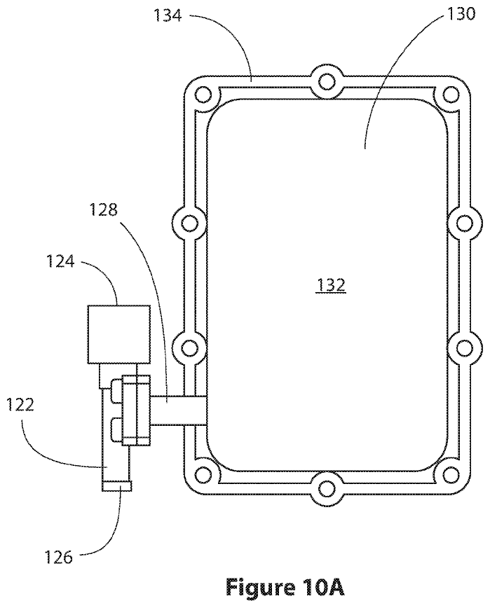

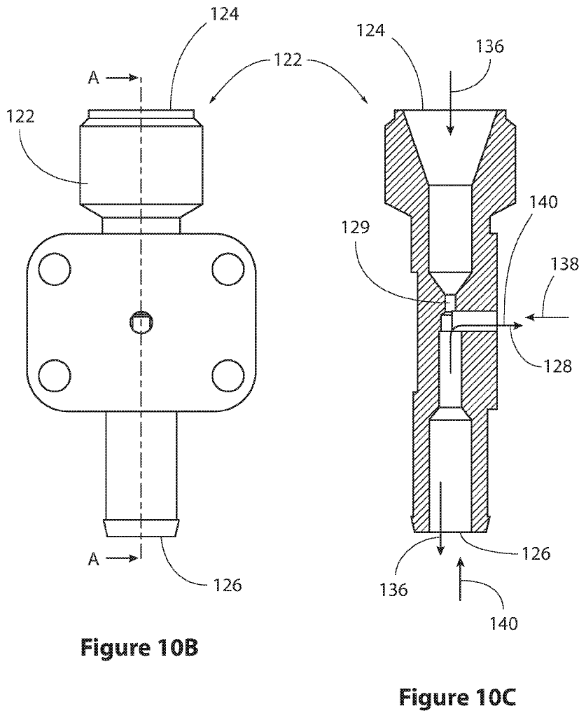

Optionally one of or both of the pipework branches may be fitted with a bladder and venturi arrangement as discussed further below with respect to FIG. 10.

The output water flow arrangements in the tap assembly of FIG. 5 are as follows.

Operation of mixer valve 8 causes hot, cold or mixed water to proceed as flow 24 to manifold connection 26.

When selector control button 74 is pressed briefly once, a solenoid valve in one branch of flow 22c within the box of extra hot water processing station 34 opens—to allow filtered cold water from flow 22c to proceed to the manifold connection 26 as flow 82. LED light 76 glows green. Pressing the button 74 briefly again closes the solenoid valve, stopping flow 82 and turning off light 76.

When selector control button 74 is pressed continuously, the solenoid valve in the other branch of flow 22c within the box of station 34 opens allowing cold filtered water into the base of the hot water tank in station 34. Displaced extra hot water flows out of station 34 as flow 36 to manifold connection 26. LED light 76 glows red. Releasing the continuously pressed button 74 causes the solenoid valve to close, stopping extra hot water flow 36 and turning off light 76.

From manifold connection 26 a water flow input (24, 36 or 82) proceeds as output flow 28 through valve body 6 and out of spout end 4.

Optionally in the arrangement of FIG. 5 the container box for extra hot water processing station 34 may optionally also contain a chiller unit that is fed with cold filtered water from the flow 22c, so that the output flow 82 to manifold connection 26 is chilled filtered water.

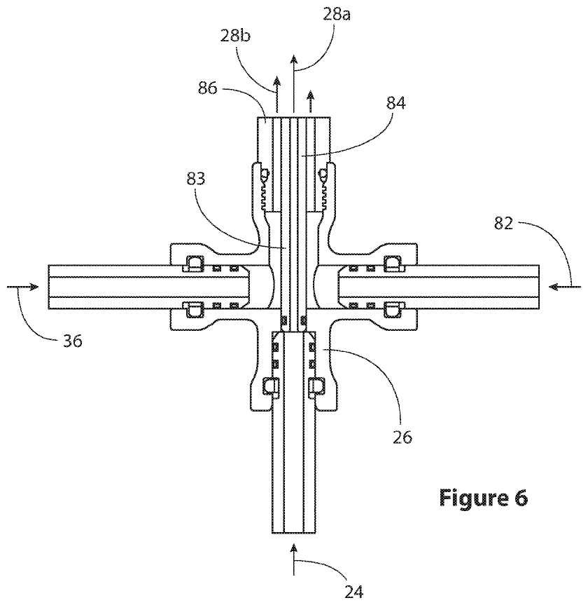

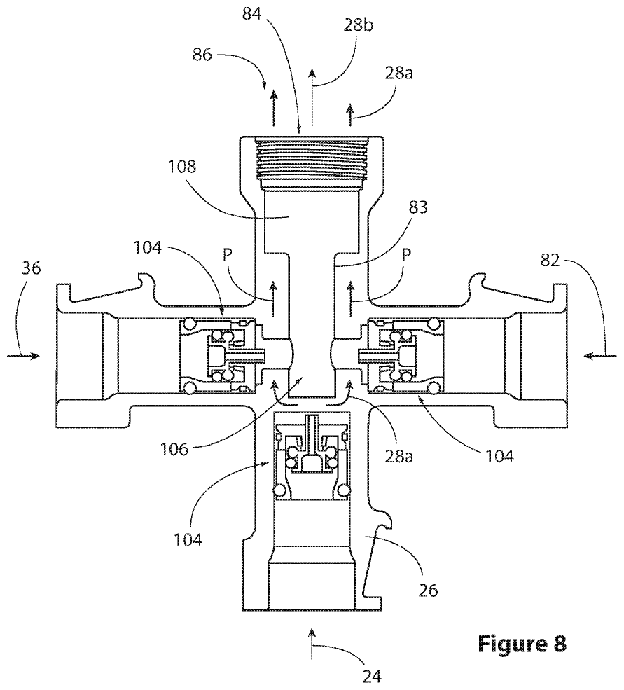

In the example of FIG. 5 the output flow 28 runs through a hose or pipe that has one hose or pipe inside another. The internal structure of a manifold connection 26 of FIG. 5 is shown in schematic cross section FIG. 6 and illustrates the use of this ‘two hose’ or pipe arrangement. An alternative manifold connection is shown in schematic cross section FIG. 8 as discussed below.

In FIG. 6 manifold connection 26 is a “cross piece” into which hoses carrying the water flows are fitted in a generally conventional way. Not shown in this schematic are optional non-return valves that can be fitted at or near the manifold connection 26 to prevent flow back, against the desired directions of flow as shown by arrows 24, 36, 82 and 28a/28b. In manifold connection 26, the hose carrying flow 24 connects to an extension 83 of inner hose 84 to allow water from mixer valve 8 (FIG. 5) to continue as flow 28a towards the tap. The hoses carrying filtered water flow 82 and extra hot water flow 36 connect into the manifold connection to allow their outputs to continue as flow 28b in the annulus between inner hose 84 and outer hose 86. Thus, the processed water flows 36, 82 are kept separate from the conventional hot/cold/mixed water flow 24. In alternative manifold connection arrangements, the processed water flows 36, 82 can be directed to the central hose 84 and the conventional flow 24 into the annulus between inner and outer hoses 84, 86.

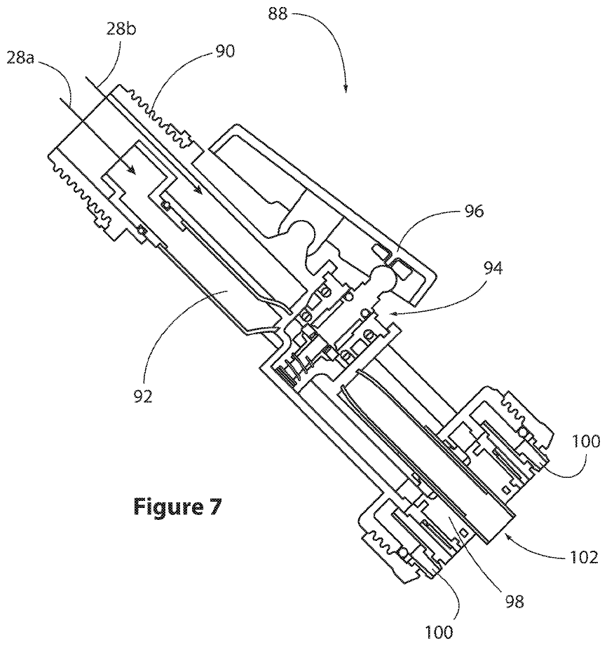

FIG. 7 shows the end of a pull put hose tap arrangement that makes use of the water supplied from the manifold connection 26 of FIG. 6.

In cross section FIG. 7 the pull out hose end 88 includes a connection end 90 for fitting to a two hose arrangement such as that shown in FIG. 6. The flow 28a from inner hose 84 (FIG. 6) is directed into chamber 92 and thence to valve 94 controlled by lever 96. From valve 94 the flow 28a can be directed to emanate from either normal outlet 98 or spray outlets 100 depending on the position of valve 94. The flow 28b from the annulus between hose 84 and outer hose 86 (FIG. 6) is always directed into outlet 102, positioned in the centre of outlet 98. Thus, the filtered water or extra hot water supply of flow 28b crosses over at the hose end 88 and becomes the central flow out of the tap.

FIG. 8 shows a manifold connection 26 in schematic cross section. This arrangement is an alternative to that shown in FIG. 6. In the manifold connection 26 of this figure each connection to input water flows 24, 36 and 82 is provided with a non-return valve 104. A T piece connector 106 provides a fluid communication from flows 36 and 82 (extra hot water and filtered water) to the extension 83 of inner hose 84 that is provided on screw connection 108. Thus, flow 28b (extra hot water or filtered water) is within the inner hose 84 in this example. (Screw connection 108 accepts a hose including inner 84 and outer 86 hoses as indicated by the numbered arrows.)

A fluid pathway past the T piece 106 and extension 83 is provided in the body of the manifold connection 26. This pathway (arrows P) allows flow 24 (from the mixer valve 8—FIG. 5) to pass into the annulus between outer hose 86 and inner hose 84 as flow 28a. Thus, flow 28a (water from the mixer valve) is within the outer hose 86 in this example. With this arrangement the processed water arrives at the outlet end of the tap already in the centre, with the water from the mixer valve in the annulus outside. Thus, a simpler tap end than that depicted in FIG. 7 can be employed. A valve converting flow 28a to a spray may still be fitted.

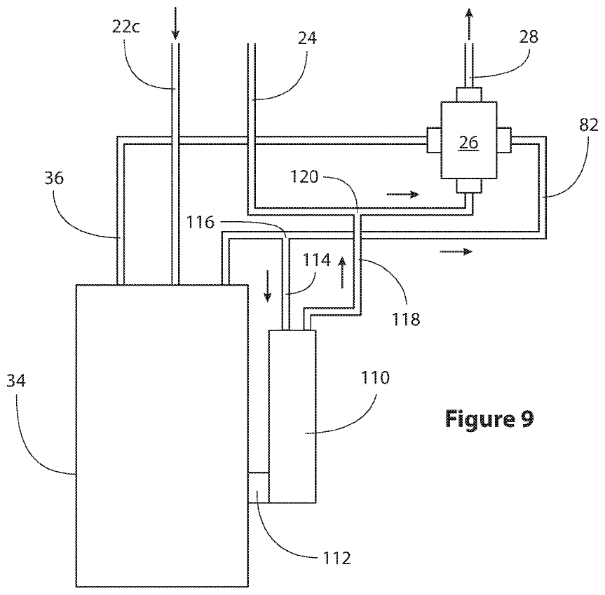

FIG. 9 shows schematically part of a tap assembly arrangement similar to that of FIG. 5 but including an ozoniser 110. In this partial view the tank of extra hot water processing station 34 and the manifold 26 are shown, together with their hose or pipe connections for the various water flows. Ozoniser 110 is mounted to the extra hot water processing station 34 including by a plug and socket electrical connection 112. In this example the input water flow 114 to ozoniser 110 is taken from flow 82 (filtered water proceeding to the manifold 26) via T piece 116. Flow 114 will commence when commanded by a flow control at or near the tap (not shown in this figure), which directs opening of a solenoid or electrically powered valve inside the body of ozoniser 110. The output ozonised water flow 118 connects into the mixer valve flow 24 and proceeds to manifold 26 and hence to output flow 28.

The ozoniser 110 in this example is provided with electrical power via the extra hot water processing station 34. Alternatively, other connection to power may be made.

One or more one way (non-return) valves may be fitted near T piece 120 to prevent flow, except in the desired direction.

FIG. 10A shows an optional venturi and bladder arrangement in elevation view. This arrangement may be fitted after one of or both of the solenoid valves provided in box of hot water station 34 as discussed above with respect to FIG. 5. The arrangement is generally that described in international patent application WO2016/110721 (Aqualogic NT Limited), the whole contents of which are incorporated by reference herein. When used with a hot water system the bladder provides capacity for the increased volume when heated water expands.

As can be seen in FIG. 10A a pipe section in the form of a venturi 122 has an inlet 124 (fed from a flow e.g. flow 22c of FIG. 5) and an outlet 126 to e.g. a tank for preparing extra hot water. A ramification (branch) 128 from the venturi, at or near its narrowest point connects to a bladder 130. The bladder 130 comprises two opposed sheets 132 (only one visible). The sheets 132 are of a resiliently deformable sheet material such as a steel or a rubber sheet for example. The sheets 132 are convex shaped so as to be spaced apart and enclose a volume, except where they held together in sealing engagement around their edges by frame 134.

FIG. 10B shows venturi 122 in more detail with a cross section view along line A-A shown in FIG. 10C. When water flows through the venturi as indicated by arrows 136, the venturi will draw water from the bladder via branch 128 (arrow 138). Thus the convex shaped sheets of bladder 130 will tend to collapse towards each other as the bladder volume reduces. When the water flow stops (by closure of a solenoid valve above inlet 124), the resilience of the sheet material will tend to restore the bladder 130 towards its unstressed volume. Where the venturi connects via a water processing station (such as a hot water tank) or even directly by supply pipework to a tap outlet, then the restoration of the bladder volume will tend to suck water back from the tap, in the direction suggested by arrows 140.

Thus a venturi and bladder arrangement may be employed to empty or substantially empty pipework between a water processing station (or other water supply) and the end of a tap. This can be achieved where non-return valves are not fitted. This arrangement can be advantageous. For example in removing a quantity of extra hot water left in the pipework after using the tap. Otherwise the extra hot water may dribble out unexpectedly.

Similarly a venturi and bladder arrangement fitted to the cold filtered water supply (FIG. 5 discussed above) can clear water from the pipework by the same mechanism. This removal of residual cold water from the pipework to the tap can also avoid dripping when the extra hot water tank is heating water up to the required temperature. The cleared pipework from the extra hot water tank to the tap provides a further space for expansion of the heated water, in addition to that provided by the venturi arrangement on the extra hot water arrangement.

1. A multifunction tap assembly for dispensing water, the tap assembly comprising:
a) a tap body including a spout for dispensing water;
b) a valve body;
c) a mixer valve on the valve body including an inlet for water from a hot water supply, an inlet for water from a cold water supply, and an outlet;
d) a selector control for selectively directing cold water from a cold water supply to one or more water processing stations;
e) one or more water processing stations, each having an inlet for receiving cold water from the cold water supply as directed by the selector control; and
each formed and arranged to process the cold water received to provide a processed water for dispensing from a respective processing station outlet; and
f) a manifold connection, the manifold connection in fluid communication with the mixer valve outlet and each processing station outlet; and having a manifold outlet in fluid communication with the spout.

2. The multifunction tap assembly of claim 1 wherein the selector control is an electronic control activated by a user of the tap to send a signal by wire or wirelessly, to command operation of a valve or valves.

3. The multifunction tap assembly of claim 1 wherein the selector control is a selector valve on the valve body for selectively dispensing cold water from a cold water inlet to one or more water processing stations via a respective selector valve outlet.

4. The multifunction tap assembly of claim 1 wherein the valve body is mounted transverse to the spout and the mixer valve and the selector control are mounted one at either end of the valve body.

5. The multifunction tap assembly of claim 1 wherein one of the water processing stations provides extra hot water.

6. The multifunction tap assembly of claim 1 wherein one of the water processing stations provides ozonised water.

7. The multifunction tap assembly of claim 6 wherein ozonised water from the ozoniser is directed via the manifold to a fluid pathway that allows the water flow dispensed from the tap to be used as a spray.

8. The multifunction tap assembly of claim 1 wherein one of the water processing stations provides extra hot water and another provides ozonized water; and
wherein tan ozoniser, providing ozone for the ozonized water, makes use of the same electrical supply as that used to heat the extra hot water.

9. The multifunction tap assembly of claim 8 wherein the ozoniser is supplied as an optional accessory that is electrically connectable to the extra hot water processing station.

10. The multifunction tap assembly of claim 1 wherein at least one route for water dispensing is without substantial obstruction to forwards flow from the spout, after water leaves the mixer valve or a water processing station.

11. The multifunction tap assembly of claim 10 wherein each route for water dispensing is without substantial obstruction to forwards flow from the spout, after water leaves the mixer valve or a water processing station.

12. The multifunction tap assembly of claim 1 wherein the spout comprises a pull out hose.

13. The multifunction tap assembly of claim 12 wherein the pull out hose is self-retracting into a tube of the tap body.

14. The multifunction tap assembly of claim 12 wherein the pull out hose connects directly to the manifold outlet.

15. The multifunction tap assembly of claim 1 wherein water flow from the mixer valve is directed along a separate fluid pathway to the spout from that of water from at least one water processing station.

16. The multifunction tap assembly of claim 1 wherein the outlet end of the spout is provided with a nozzle for adjusting a water flow into a spray.

17. The multifunction tap assembly of claim 15 wherein the outlet end of the spout is provided with a nozzle for adjusting a water flow into a spray and;
wherein the nozzle acts to provide a spray only from the water flow from the mixer valve.

18. The multifunction tap assembly of claim 2 wherein the electronic control comprises at least one of a push button, a lever, a rotating dial, or a touch pad type of activation interface with a user.

19. The multifunction tap assembly of claim 2 wherein the electronic control comprises one or more proximity switches.

20. The multifunction tap assembly of claim 2 wherein one of the water processing stations provides extra hot water; and
wherein the dispensing of extra hot water continues only whilst contact is maintained between the user and a button lever or dial.

21. The multifunction tap assembly of claim 2 wherein one of the water processing stations provides extra hot water; and
wherein the electronic control is conformed to require two conscious actions by a user to activate and/or control dispensing of extra hot water.

22. The multifunction tap assembly of claim 3 wherein the cold water inlet for the mixer valve on the valve body provides the cold water supply to the selector valve.

23. The multifunction tap assembly of claim 22 wherein the cold water inlet divides in two at the valve body, with cold water supplied to the mixer valve and the selector valve.

24. The multifunction tap assembly of claim 23 wherein the cold water inlet connects to a chamber of the valve body that receives the cold water, the chamber connecting to the selector valve and to the mixer valve, for supply to both.

25. The multifunction tap assembly of claim 1 comprising at least one water processing station selected from the group consisting of:
a water filter, an extra hot water dispenser, an ozonised water dispenser, a water softener, a water chiller, a chemical treatment water purifier, a UV light water purifier and a carbonated water dispenser.

26. The multifunction tap assembly of claim 25 comprising two or more water processing stations.

27. The multifunction tap assembly of claim 1 wherein at least one water processing station is provided with a venturi and bladder arrangement to provide a pipework clearing action at the tap, after use.

28. The multifunction tap assembly of claim 5 wherein the extra hot water processing station is provided with a timer control to turn off the heating during periods when extra hot water is not required

29. A multifunction tap, the multifunction tap comprising:
a) a tap body including a spout for dispensing water;
b) a valve body including a cold water inlet;
c) a mixer valve on the valve body including an inlet for water from a hot water supply, an inlet for water from a cold water supply, and an outlet; and
d) a selector control on the tap body or the valve body for selectively directing cold water from a cold water supply to one or more water processing stations.

30. A multifunction tap assembly for dispensing water; the tap assembly comprising:
a) a tap body including a spout for dispensing water;
b) a valve body;
c) a mixer valve on the valve body including an inlet for water from a hot water supply, an inlet for water from a cold water supply, and an outlet;
d) a selector control for selectively directing cold water from a cold water supply to one or more water processing stations;
e) at least an extra hot water processing station and an ozonised water producing station, each having an inlet for receiving cold water from the cold water supply as directed by the selector control; and each formed and arranged to process the cold water received to provide processed water for dispensing from a respective processing station outlet; and
f) a manifold connection, the manifold connection in fluid communication with the mixer valve outlet and each processing station outlet; and having a manifold outlet in fluid communication with the spout.
